(19) United States
(12) Patent Application Publication
(10) Pub. No.: US 2005/0064885 A1
(43) Pub. Date: Mar. 24, 2005

(54) System and method for alarming an incoming message of a mobile communication terminal

(75) Inventor: Sun-Dong Lee, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CURITEL COMMUNICATION, INS.

(21) Appl. No.: 10/788,429

(22) Filed: Feb. 27, 2004

(30) Foreign Application Priority Data
Sep. 19, 2003 (KR) 10-2003-0065175

(51) Int. Cl. H04Q 7/20

(52) U.S. Cl. 455/466

(57) ABSTRACT

In a system and method for alarming an incoming message of a mobile communication terminal, incoming message alarming information indicating incoming message's arrival is transmitted over the Internet by using a messenger to a personal computer (PC) which a called subscriber has logged in. Thus, even when the mobile communication terminal is in a vibration mode or lamp mode, the incoming message's arrival may easily be perceived and the content of the incoming message may be obtained without using the mobile communication terminal.

### CROSS-REFERENCE TO RELATED APPLICATION

The entire disclosure of Korean Patent Application No. 10-2003-0065175 filed on Sep. 19, 2003 including specification, claims, drawings and summary are incorporated herein by reference in its entirety.

### BACKGROUND OF THE INVENTION

1. Field of the Invention

The present invention relates to a system and method for alarming an incoming message of a mobile communication terminal, and more particularly to a system and method for alarming an incoming message of a mobile communication terminal wherein incoming message alarming information indicating an incoming message's arrival is transmitted, through a messenger service, to a personal computer (PC) which a called subscriber has logged in.

2. Description of the Prior Art

Generally, in a mobile communication terminal, it can be checked whether or not a call or a short message, etc. has arrived at a mobile communication terminal through bell sounds, vibration, lamp light and so on. Office workers who conduct their businesses on their personal computers (PCs) generally set their mobile communication terminals to a vibration mode or lamp mode for a call or a short message because, otherwise, other people may be disturbed by the bell sounds from mobile communication terminals.

However, often times, such office workers may be unable to recognize whether or not a call or a message have arrived at the mobile communication terminal.

### SUMMARY OF THE INVENTION

Accordingly, the present invention has been made to solve the above-mentioned problems occurring in the prior art, and an object of the present invention is to provide a system and method for alarming an incoming message of a mobile communication terminal to a personal computer (PC) which a called subscriber has logged in.

In order to accomplish this object, there is provided an incoming message alarming system, including: a wireless communication system for receiving an incoming message from a calling mobile communication terminal and transmitting base alarm information including an identification of the calling mobile communication terminal; and a messenger service system for receiving the base alarm information from the wireless communication system and informing a called subscriber of arrival of the incoming message through a messenger service.

Preferably, the wireless communication system may include: a base station for receiving the incoming message from the calling mobile communication terminal; a mobile switching center for receiving the incoming message from the base station and transmitting the base alarm information to a messenger service system; and a Home Location Register for storing location information of the called subscriber, subscriber information on whether or not the called subscriber is an incoming message alarming service subscriber, and flag information indicating an activation state of the incoming message alarming service, and wherein the messenger service system may include: a messenger server for receiving the base alarm information from the wireless communication system and transmitting incoming message alarming information indicating arrival of the incoming message to the called mobile communication terminal; and a messenger information database for storing an IP address and a messenger ID of the called subscriber, wherein the messenger server informs the called subscriber of the incoming message's arrival by using the IP address.

Alternatively, the messenger service system may include a messenger server for receiving the base alarm information from the wireless communication system and transmitting incoming message alarming information indicating arrival of the incoming message to the called mobile communication terminal, wherein the messenger server may include a messenger information database for storing an IP address and a messenger ID of the called subscriber.

Preferably, the messenger server may ask the called subscriber whether to use the incoming message service and store resultant information on whether to use the incoming message service (“use information”) in the messenger information database.

Preferably, the flag information may be updated by the use information.

Preferably, the messenger server may transmit the incoming message alarming information to the called subscriber, with reference to the flag information, when the incoming message alarming service has been activated.

Preferably, the messenger server may temporarily store the incoming message alarming information, with reference to the flag information, when the incoming message alarming service has not been activated.

In order to accomplish the above object, there is provided a wireless communication system, including: a base station for receiving an incoming message from a calling mobile communication terminal; and a mobile switching center for receiving the incoming message from the base station and transmitting base alarm information to a messenger service system.

Preferably, the base alarm information may be at least one of identifications of a calling mobile communication terminal sending the incoming message and the called mobile communication terminal, if the incoming message is a call, and may be at least one of identifications of a calling mobile communication terminal and the called mobile communication terminal, and the content of a short message, if the incoming message is the short message.

Preferably, the mobile switching center may temporarily store the base alarm information when the base alarm information is not able to be transmitted to the messenger service system.

In order to accomplish the above object, there is provided a messenger service system, including: a messenger server for transmitting to a called mobile communication terminal incoming message alarming information indicating arrival of an incoming message transmitted from a calling mobile communication terminal; and a messenger information database for storing an IP address and a messenger ID of the called subscriber, wherein the messenger server informs the called subscriber of the incoming message's arrival by using the IP address.

Preferably, the messenger server may transmit the incoming message alarming information through internet to the called subscriber who has logged in a messenger service.

Preferably, the messenger server may temporarily store the incoming message alarming information when the incoming message alarming information is not able to be transmitted to the called subscriber.

Preferably, the incoming message alarming information may be at least one of an identification of a calling mobile communication terminal sending the incoming message and information indicating the incoming message's arrival, if the incoming message is a call, and may be at least one of an identification of the calling mobile communication terminal and the content of a short message, if the incoming message is the short message.

In order to achieve the above object, there is provided another messenger service system, including a messenger server for transmitting to a called mobile communication terminal incoming message alarming information indicating arrival of an incoming message transmitted from a calling mobile communication terminal and wherein the messenger server includes a messenger information database for storing an IP address and a messenger ID of the called subscriber.

Preferably, the messenger server may transmit the incoming message alarming information through internet to the called subscriber who has logged in a messenger service.

Preferably, the messenger server may temporarily store the incoming message alarming information when the incoming message alarming information is not able to be transmitted to the called subscriber.

In order to achieve the above object, there is provided a method for alarming an incoming message of a mobile communication terminal, including: transmitting base alarm information including an identification of a called mobile communication terminal; receiving the base alarm information and searching an IP address corresponding to the identification of the called mobile communication terminal; and alarming arrival of the incoming message to a called subscriber by using the searched IP address through a messenger service.

Preferably, said transmitting base alarm information may include: receiving an incoming message from a calling mobile communication terminal; checking whether or not the called subscriber is an incoming message alarming service subscriber; if the called subscriber is an incoming message alarming service subscriber, checking whether or not the incoming message alarming service has been activated; and if the incoming message alarming service has been activated, transmitting the base alarm information.

Preferably, said alarming arrival of the incoming message to a called subscriber may include: checking whether or not the called subscriber has logged in the messenger service; if the called subscriber has logged in the messenger service, checking whether or not the called subscriber wants to use the incoming message alarming service; if the called subscriber wants to use the incoming message alarming service, transmitting the incoming message alarming information to a personal computer which the called subscriber has logged in; and creating an incoming message alarming window indicating the incoming message's arrival.

Preferably, said transmitting base alarm information may further include: if the incoming message alarming service has not been activated, temporarily storing the base alarm information until the incoming message alarming service is activated; and when the incoming message alarming service is activated, transmitting the base alarm information.

Preferably, said alarming arrival of the incoming message to a called subscriber may further include: if the incoming message alarming service has not been activated, temporarily storing the incoming message alarming information until the incoming message alarming service is activated; and
when the incoming message alarming service is activated, transmitting the incoming message alarming information to the personal computer.

### BRIEF DESCRIPTION OF THE DRAWINGS

The above and other objects, features and advantages of the present invention will be more apparent from the following detailed description taken in conjunction with the accompanying drawings, in which:

FIG. 1 is a constructional view of an incoming message alarming system according to a preferred embodiment of the present invention;

FIG. 2 is an illustration of an incoming message alarming window according to a preferred embodiment of the present invention;

FIG. 3 is a flow chart showing an incoming message alarming service procedure of a mobile switching center according to a preferred embodiment of the present invention;

FIG. 4 is a flow chart showing an incoming message alarming service procedure of a messenger server according to a preferred embodiment of the present invention;

### DETAILED DESCRIPTION OF THE PREFERRED EMBODIMENTS

Hereinafter, a preferred embodiment of the present invention will be described with reference to the accompanying drawings.

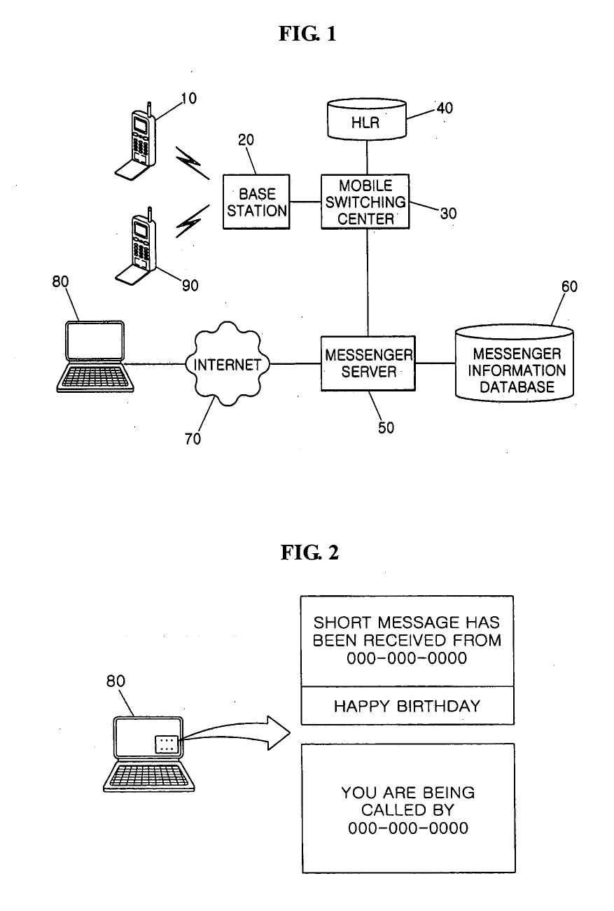

As shown in FIG. 1, an incoming message alarming system includes a calling mobile communication terminal 10, a called mobile communication terminal 90, a base station 20, a mobile switching center (MSC) 30, a Home Location Register (HLR) 40, a messenger server 50, a messenger information database 60, and a personal computer 80 connected to the messenger server 50 over the Internet 70.

The calling mobile communication terminal 10 is a mobile communication terminal of a calling subscriber who sends a call or a short message, etc. (hereinafter, collectively referred to as an “incoming message”) to a mobile communication service subscriber registered with an incoming message alarming service. The called mobile communication terminal 90 is a mobile communication terminal of a called subscriber to whom the incoming message is directed.

The base station 20 transmits an incoming message, which is received from the calling mobile communication terminal 10, to the mobile switching center 30 and transmits the incoming message received from the mobile switching center 30 to the called mobile communication terminal 90. For convenience of description, it is assumed in this application that the called mobile communication terminal 90 is located within the same base station 20 sector (i.e., cell) as the calling mobile communication terminal 10.

The mobile switching center 30 receives the incoming message of the calling mobile communication terminal 10 through the base station 20, and searches location information of the called subscriber through the HLR 40 to route the received incoming message to the called mobile communication terminal 90 through the base station 20.

Here, while searching the location information through the HLR 40, the mobile switching center 30 checks whether or not the called subscriber is an incoming message alarming service subscriber. If the called subscriber is an incoming message alarming service subscriber, base alarm information is transmitted to the messenger server 50.

For example, if the received incoming message is a call, the may include identifications (e.g., mobile communication terminal number) of the calling mobile communication terminal 10 and the called mobile communication terminal 90. On the other hand, if the received incoming message is a short message, the base alarm information may include identifications of the calling/called mobile communication terminals 10 and 90 and optionally a content of the short message. The base alarm information may include more information not described in this specification since the incoming message in this specification is not simply limited to the call and the short message.

Furthermore, before transmitting the base alarm information, the mobile switching center 30 checks whether the incoming message alarming service has been activated. Therefore, it is preferable that the base alarm information can be transmitted when the incoming message alarming service has been activated. However, the mobile switching center 30 can be configured such that the MSC temporarily stores the incoming message therein when the incoming message alarming service has not been activated and then transmits the incoming message to the called subscriber's PC 80 when the incoming message alarming service is activated.

The HLR 40 stores the location information of the called subscriber. The HLR 40 stores subscriber information on whether or not the called subscriber is an incoming message alarming service subscriber. Moreover, the HLR 40 stores flag information indicating an activation state of the incoming message alarming service, i.e., whether or not the incoming message alarming service has been activated by the incoming message alarming service subscriber.

The information stored in the HLR 40 such as the location information, the subscriber information, and the flag information is updated by the mobile switching center 30 receiving the corresponding information from the messenger server 50.

The messenger server 50 functions to show the incoming message on the personal computer 80 connected to the mobile switching center over the Internet 70. When the base alarm information is received from the mobile switching center 30, a messenger ID and an IP address of the called subscriber are searched through the messenger information database 60. It is checked whether or not the called subscriber has logged in the messenger service, by using the messenger ID. Then, when the called subscriber has logged in the messenger service, incoming message alarming information indicating the incoming message's arrival is transmitted to the personal computer 80 which the called subscriber has logged in over the Internet 70 by using the searched IP address.

If the incoming message is a call, the incoming message alarming information may include the identification (e.g., mobile communication terminal number or caller's name) of the calling mobile communication terminal 10 and the information indicating the incoming call's arrival. On the other hand, if the incoming message is a short message, the incoming message alarming information may include the identification of the calling mobile communication terminal 10 and optionally the content of the short message. The incoming message alarming information may also include more information not described in this specification since the incoming message in this specification is not simply limited to the call and the short message.

The messenger information database 60 stores the messenger ID and the IP address of the called subscriber. Further, the messenger information database 60 may be integrally implemented with the messenger server 50.

Alternatively, when a called subscriber logs in the messenger service through his/her own personal computer 80, the messenger server 50 asks the called subscriber whether to use the incoming message alarming service through the personal computer 80, stores the resultant information on whether to use the incoming message alarming service (“use information”) received from the personal computer 80 in the messenger information database 60, and transmits the stored use information to the mobile switching center 30. Here, the flag information stored in the HLR 40 is updated by the use information transmitted from the messenger server 50. If, during the incoming message alarming service, the called subscriber logs off the incoming message alarming service or does not want to use the incoming message alarming service, the messenger server 50 detects this situation, stores the use information in the messenger information database 60, and then transmits the stored use information to the mobile switching center 30 to update the flag information.

Thus, preferably the mobile switching center 30 transmits the base alarm information for the called subscriber who wants to use the incoming message alarming service. The IP address of the called subscriber is searched at the messenger information database 60, and then, using the IP address, the incoming message alarming information indicating the incoming message's arrival is transmitted over the Internet 70 to the personal computer 80 which the called subscriber has logged in.

In the messenger information database 60, the identification of the mobile communication terminal corresponding to the messenger ID of the incoming message alarming service subscriber is stored together with the use information of the incoming message alarming service indicating the activated or inactivated state of the incoming message alarming service. The messenger information database 60 may be integrally implemented with the messenger server 50.

When an inquiry on whether to use the incoming message alarming service is made from the messenger server 50, the personal computer 80 transmits the use information as specified by the subscriber to the messenger server 50 over the Internet 70. When the incoming message alarming information is received from the messenger server 50 over the Internet 70, an incoming message alarming window is created on the personal computer 80, as shown in FIG. 2. Through the incoming message alarming window, the incoming message alarming information indicating that the called mobile communication terminal 90 is being called or a short message is arriving at the called mobile communication terminal 90 is displayed.

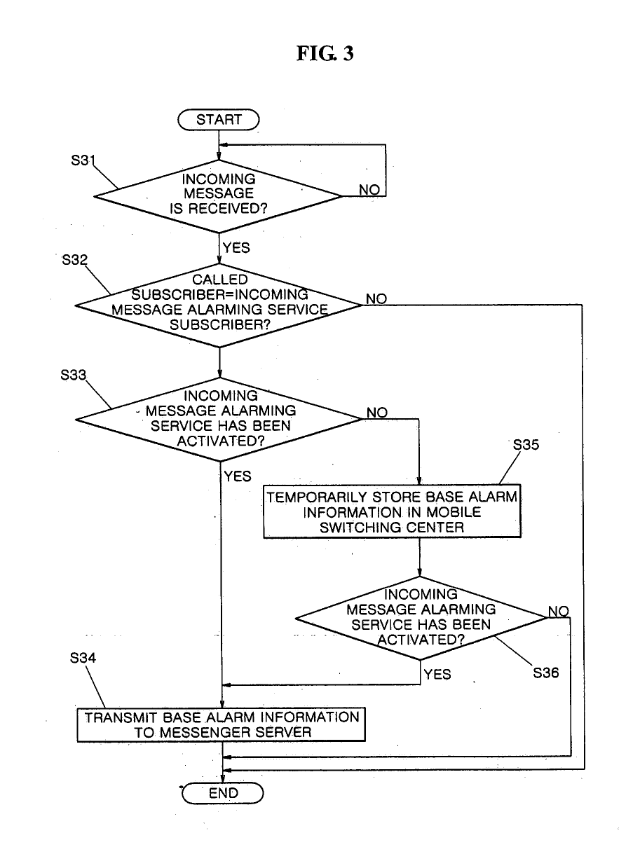

FIG. 3 is a flow chart showing an incoming message alarming service procedure of the mobile switching center 30 according to a preferred embodiment of the present invention.

As shown in FIG. 3, when an incoming message is received from the calling mobile communication terminal 10 (S31), the mobile switching center 30 searches the subscriber information stored in the HLR 40 to check whether or not the called subscriber is an incoming message alarming service subscriber (S32). Upon the check, if the called subscriber is determined to be an incoming message alarming service subscriber, the mobile switching center 30 searches the flag information stored in the HLR 40 to check whether or not an incoming message alarming service has been activated (S33).

As a result of the above check, if the called subscriber is determined to be an incoming message alarming service subscriber and, also, the incoming message alarming service has been activated, the base alarm information is transmitted to the messenger server 50 (S34).

Alternatively, as a result of the above check, if the called subscriber is determined to be an incoming message alarming service subscriber but the incoming message alarming service has not been activated, the base alarm information may temporarily be stored in the mobile switching center 30 until the incoming message alarming service has been activated (S35). Then, when the incoming message alarming service is activated (S36), the base alarm information may be transmitted to the messenger server 50 (S34).

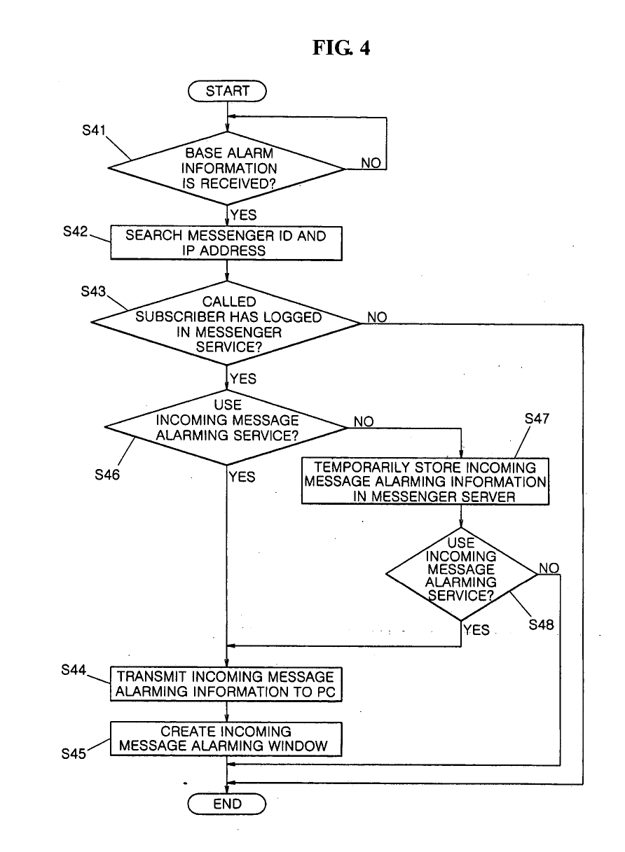

FIG. 4 is a flow chart showing an incoming message alarming service procedure of the messenger server 50 according to a preferred embodiment of the present invention.

As shown in FIG. 4, the messenger server 50 checks whether or not the base alarm information is received from the mobile switching center 30 (S41). If the base alarm information has been received, the messenger server 50 searches the messenger ID and the IP address of the called subscriber stored in the messenger information database 60 by using the identification of the called mobile communication terminal 90 which is contained in the base alarm information (S42).

Then, it is checked whether or not the called subscriber has logged in the messenger service through the personal computer 80 by using the searched messenger ID (S43).

Upon the check, if the called subscriber has logged in the messenger service, the incoming message alarming information indicating an incoming message's arrival is transmitted over the Internet 70 by using the searched IP address to the personal computer 80 which the called subscriber has logged in (S44). If the incoming message is a call, the incoming message alarming information includes the identification of the calling mobile communication terminal 10 and information indicating that the called mobile communication terminal 90 is being called. Further, if the incoming message is a short message, the incoming message alarming information includes the identification of the calling mobile communication terminal 10 and optionally the content of the short message.

Then, the personal computer 80 which has received the incoming message alarming information creates an incoming message alarming window (e.g., pop-up window) as shown in FIG. 2 on the personal computer 80 of the called subscriber (S45).

Alternatively, when the called subscriber has logged in the messenger service, the messenger server may ask the called subscriber whether or not to use the incoming message alarming service (S46) . If it is determined that the called subscriber wants to use the incoming message alarming service, the incoming message alarming information may be transmitted to the personal computer. On the other hand, if it is determined that the called subscriber does not want to use the incoming message alarming information, the messenger server may temporarily store the incoming message alarming information (S47). Then, when the called subscriber wants to use the incoming message alarming service, that is, when the incoming message alarming service is activated, the incoming message alarming information may be transmitted to the personal computer.

Although preferred embodiments of the present invention have been described for illustrative purposes, those skilled in the art will appreciate that various modifications, additions and substitutions are possible, without departing from the scope and spirit of the invention as disclosed in the accompanying claims.

As explained in the foregoing, the present invention provides, by using the messenger, incoming message alarming information, which indicates incoming message's arrival, to the personal computer which the user of the mobile communication terminal has logged in and is using over the Internet. Thus, it is made possible to readily recognize the incoming message's arrival at the mobile communication terminal even when the mobile communication terminal is in a vibration or lamp mode. Further, it becomes possible to obtain the content of the incoming message without using the mobile communication terminal.

1. An incoming message alarming system, comprising:
a wireless communication system for receiving an incoming message from a calling mobile communication terminal and transmitting base alarm information including an identification of the calling mobile communication terminal; and
a messenger service system for receiving the base alarm information from the wireless communication system and informing a called subscriber of arrival of the incoming message through a messenger service.

2. The incoming message alarming system of claim 1, wherein the wireless communication system comprises:
a base station for receiving the incoming message from the calling mobile communication terminal;
a mobile switching center for receiving the incoming message from the base station and transmitting the base alarm information to a messenger service system; and
a home location register for storing location information of the called subscriber, subscriber information on whether or not the called subscriber is an incoming message alarming service subscriber, and flag information indicating an activation state of the incoming message alarming service, and wherein the messenger service system comprises:
a messenger server for receiving the base alarm information from the wireless communication system and transmitting incoming message alarming information indicating arrival of the incoming message to the called mobile communication terminal; and
a messenger information database for storing an internet protocol (IP) address and a messenger identification (ID) of the called subscriber,
wherein the messenger server informs the called subscriber of the incoming message's arrival by using the IP address.

3. The incoming message alarming system of claim 1, wherein the messenger service system comprises a messenger server for receiving the base alarm information from the wireless communication system and transmitting incoming message alarming information indicating arrival of the incoming message to the called mobile communication terminal, and wherein the messenger server comprises a messenger information database for storing an IP address and a messenger ID of the called subscriber.

4. The incoming message alarming system of claim 2, wherein the messenger server asks the called subscriber whether to use the incoming message service and stores resultant information on whether to use the incoming message service (“use information”) in the messenger information database.

5. The incoming message alarming system of claim 4, wherein the flag information is updated by the use information.

6. The incoming message alarming system of claim 5, wherein the messenger server transmits the incoming message alarming information to the called subscriber, with reference to the flag information, when the incoming message alarming service has been activated.

7. The incoming message alarming system of claim 5, wherein the messenger server temporarily stores the incoming message alarming information, with reference to the flag information, when the incoming message alarming service has not been activated.

8. A wireless communication system, comprising:
a base station for receiving an incoming message from a calling mobile communication terminal; and
a mobile switching center for receiving the incoming message from the base station and transmitting base alarm information to a messenger service system.

9. The wireless communication system of claim 8, wherein the base alarm information is at least one of identifications of a calling mobile communication terminal sending the incoming message and the called mobile communication terminal, if the incoming message is a call, and is at least one of identifications of a calling mobile communication terminal and the called mobile communication terminal, and the content of a short message, if the incoming message is the short message.

10. The wireless communication system of claim 8, wherein the mobile switching center temporarily stores the base alarm information when the base alarm information is not able to be transmitted to the messenger service system.

11. A messenger service system, comprising:
a messenger server for transmitting to a called mobile communication terminal incoming message alarming information indicating arrival of an incoming message transmitted from a calling mobile communication terminal; and
a messenger information database for storing an IP address and a messenger ID of the called subscriber,
wherein the messenger server informs the called subscriber of the incoming message's arrival by using the IP address.

12. The messenger service system of claim 11, wherein the messenger server transmits the incoming message alarming information through internet to the called subscriber who has logged in a messenger service.

13. The messenger service system of claim 11, wherein the messenger server temporarily stores the incoming message alarming information when the incoming message alarming information is not able to be transmitted to the called subscriber.

14. The messenger service system of claim 11, wherein the incoming message alarming information is at least one of an identification of a calling mobile communication terminal sending the incoming message and information indicating the incoming message's arrival, if the incoming message is a call, and is at least one of an identification of the calling mobile communication terminal and the content of a short message, if the incoming message is the short message.

15. A messenger service system, comprising a messenger server for transmitting to a called mobile communication terminal incoming message alarming information indicating arrival of an incoming message transmitted from a calling mobile communication terminal and wherein the messenger server comprises a messenger information database for storing an IP address and a messenger ID of the called subscriber.

16. The messenger service system of claim 15, wherein the messenger server transmits the incoming message alarming information through internet to the called subscriber who has logged in a messenger service.

17. The messenger service system of claim 15, wherein the messenger server temporarily stores the incoming message alarming information when the incoming message alarming information is not able to be transmitted to the called subscriber.

18. A method for alarming an incoming message of a mobile communication terminal, comprising:
transmitting base alarm information including an identification of a called mobile communication terminal;
receiving the base alarm information and searching an IP address corresponding to the identification of the called mobile communication terminal; and
alarming arrival of the incoming message to a called subscriber by using the searched IP address through a messenger service.

19. The method of claim 18, wherein said transmitting base alarm information comprises:
receiving an incoming message from a calling mobile communication terminal;
checking whether or not the called subscriber is an incoming message alarming service subscriber;
if the called subscriber is an incoming message alarming service subscriber, checking whether or not the incoming message alarming service has been activated; and
if the incoming message alarming service has been activated, transmitting the base alarm information.

20. The method of claim 18, wherein said alarming arrival of the incoming message to a called subscriber comprises:
checking whether or not the called subscriber has logged in the messenger service;
if the called subscriber has logged in the messenger service, checking whether or not the called subscriber wants to use the incoming message alarming service;
if the called subscriber wants to use the incoming message alarming service, transmitting the incoming message alarming information to a personal computer which the called subscriber has logged in; and
creating an incoming message alarming window indicating the incoming message's arrival.

21. The method of claim 19, wherein said transmitting base alarm information further comprises:
if the incoming message alarming service has not been activated, temporarily storing the base alarm information until the incoming message alarming service is activated; and
when the incoming message alarming service is activated, transmitting the base alarm information.

22. The method of claim 20, wherein said alarming arrival of the incoming message to a called subscriber further comprises:
if the incoming message alarming service has not been activated, temporarily storing the incoming message alarming information until the incoming message alarming service is activated; and
when the incoming message alarming service is activated, transmitting the incoming message alarming information to the personal computer.
